(19) United States
(12) Patent Application Publication
(10) Pub. No.: US 2017/0147111 A1
(43) Pub. Date: May 25, 2017

(54) TIME-BASED SCHEDULING FOR TOUCHSCREEN ELECTRONIC DEVICES

(71) Applicant: International Business Machines Corporation, Armonk, NY (US)

(72) Inventors: Lisa Seacat De Luca, Baltimore, MD (US); Lydia M. Do, Raleigh, NC (US); Jenny S. Li, Danbury, CT (US)

(21) Appl. No.: 14/949,072

(22) Filed: Nov. 23, 2015

(51) Int. Cl. G06F 3/041; G06F 3/14; G06F 3/16

(52) U.S. Cl. CPC G06F 3/0412; G06F 3/167; G06F 3/1454

(57) ABSTRACT

Aspects relate to touchscreen electronic devices, methods, systems, and computer program products for detecting, by a processor in a touchscreen electronic device, a user-defined time detected along a time-based touch region located at an edge of a face of the touchscreen electronic device; generating an inquiry based on the detected user-defined time; transmitting the inquiry to at least one remote resource; receiving at the touchscreen electronic device time-sensitive information from the at least one remote resource; and displaying the time-sensitive information on the face of the touchscreen electronic device.

### BACKGROUND

The present disclosure relates generally to touchscreen electronic devices and, more specifically, to touchscreen electronic devices with touch-based, time-based scheduling and methods and processes thereof.

Computing, mobile, and wireless communications technologies have been rapidly advancing and have culminated in a variety of powerful user-friendly personal electronic devices such as smart phones, tablets, smart watches, etc. Today, it is possible to purchase handheld consumer electronic devices that employ wireless communication devices and that combine computing, telephone, and networking/internet features. A typical consumer electronic device may function as a cellular phone, personal organizer, network or internet access interface, entertainment device, etc.

Today, the industry is striving to provide more and more advancement by providing increased desktop computer-like functionality and convenience to a consumer while decreasing the size and power requirements of the personal electronic devices. More recently there have been attempts to incorporate some of the capabilities of the above devices, e.g., desktop computer-like functionality, into phones and wrist watches.

Wearable smartwatch devices, and other touchscreen electronic devices, are available that, besides time keeping functions, may possess Global Positioning System (GPS), barometer, heart rate monitor, Personal Handy System (PHS) phone, pager, voice-to-text, application functionality, internet connectivity, etc. Current touchscreen electronic devices may be connected to the Internet or other PC/network devices, such as a smartphone, through various wireless technologies, including Bluetooth®, Wi-Fi, etc.

Wearable smartwatches and other touchscreen electronic devices may have user interfaces that are configured to enable user interaction with applications or other programs installed on the touchscreen electronic devices. Further, some touchscreen electronic devices may be configured to access applications or other programs through a touchscreen electronic device interface, e.g., access applications located on a connected different electronic device but accessed through the interface of the touchscreen electronic device.

### SUMMARY

According to embodiments, touchscreen electronic devices, methods, systems, and computer program products are provided for detecting, by a processor in a touchscreen electronic device, a user-defined time detected along a time-based touch region located at an edge of a face of the touchscreen electronic device; generating an inquiry based on the detected user-defined time period; transmitting the inquiry to at least one remote resource; receiving at the touchscreen electronic device time-sensitive information from the at least one remote resource; and displaying the time-sensitive information on the face of the touchscreen electronic device.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1 depicts a block diagram of a system for enabling touchscreen electronic device functionality in accordance with an embodiment of the present disclosure;

FIG. 2 is a schematic block illustration of components of a touchscreen electronic device in accordance with an embodiment of the present disclosure;

FIG. 3 is a schematic illustration of a face of a touchscreen electronic device in accordance with an embodiment of the present disclosure;

FIG. 4A is a schematic illustration of the face of a touchscreen electronic device indicating a user input in accordance with an embodiment of the present disclosure;

FIG. 4B is a schematic illustration the face of the touchscreen electronic device in FIG. 4A showing results displayed on a touchscreen electronic device face in accordance with an embodiment of the present disclosure;

FIG. 5 is a schematic illustration of another touchscreen electronic device face in accordance with an embodiment of the present disclosure; and

FIG. 6 is a flow process for displaying scheduling information on the face of a touchscreen electronic device in accordance with an embodiment of the present disclosure.

### DETAILED DESCRIPTION

Embodiments described herein are directed to systems and processes for communicating between a touchscreen electronic device, such as a smartphone or a wearable smartwatch and a remote resource (e.g., a wireless or mobile device) related to scheduling and time management of a user. As described herein, a user may initialize a request from a touchscreen electronic device to a remote resource without having the user to directly interact with the remote resource, e.g., a user may not need to pull out a smartphone to view requested or desired information. As provide herein systems and processes for a user to access time-sensitive information via the touch of a touchscreen electronic device are provided.

As provided herein, a traditional watch face (e.g., analog clock face), touch-based overlay is provided on an edge of screen or face of a touchscreen electronic device, without displaying the analog clock face on the screen. For example, as known in the art, 12 o'clock is located on the top of the face, 3 o'clock is located on the right of the face, 6 o'clock is located at the bottom of the face, and 9 o'clock is located on the left of the face, when viewed by a user. As provided herein, when a user touches different parts of the edge of the touchscreen electronic device face, the touch or registration of the touch may correspond to a different selected or indicated time, hereinafter user-defined time. The user-defined time, whether a specific time or a range of time, can be used as a search criteria or filter for time-sensitive information such as TV listings, train schedules, movie show times, etc. that may be stored or accessed through a connection with a remote resource, such as a smartphone or internet based server. The result that corresponds to the user-defined time, e.g., the touched time or time frame, may be sent from the remote resource and shown to the user on the screen or face of the touchscreen electronic device.

Further, as provided herein, a user can link a touchscreen electronic device to multiple remote resources, such as a smartwatch, a smartphone, a tablet, a laptop, and an internet based server (e.g., cloud storage), so that time-sensitive applications from each of the remote resources can be accessed and provided to the touchscreen electronic device for display to a user. As such, in some embodiments, a touchscreen electronic device face can be configured to show or display consolidated results obtained from multiple remote resources.

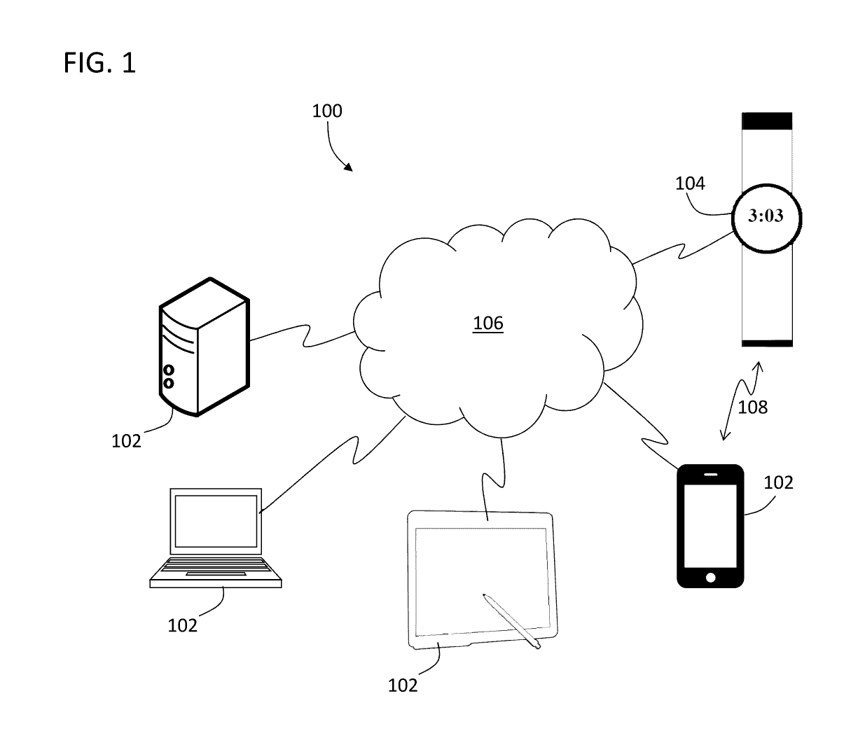

Referring to FIG. 1, a block diagram of a system 100 for using a touchscreen electronic device pertaining to a discussion in accordance with an embodiment is shown. The system 100 includes a touchscreen electronic device 104 for performing the processing and/or enabling the functions and functionality described herein that is executed by one or more computer programs located on the touchscreen electronic device 104 and/or located on one or more remote resources 102. As shown, the touchscreen electronic device 104 is a smartwatch, although other touchscreen electronic devices may employ embodiments described herein. For example, embodiments provided herein may be applied and used by any touchscreen electronic device including, but not limited to, smartwatches, smartphones, tablets, handheld electronic devices, or any other personal or other type of electronic device having a touchscreen.

Further, as shown, the system 100 may incorporate one or more remote resources 102, such as a laptop, a smartphone, a tablet, and/or a remote server or storage device (e.g., cloud-based storage) although other remote resources such as personal electronic devices or internet based sources may be used with systems and processes described herein.

The system 100 depicted in FIG. 1 includes one or more remote resources 102 which a user can access from the touchscreen electronic device 104 to initiate, interact with, and/or receive information therefrom. As shown, the remote resources 102 are coupled to the touchscreen electronic device 104 via a network 106. Some of the remote resources 102 may be implemented using general-purpose computers executing computer programs for carrying out various processes and/or programs. The remote resources devices 102 may be user devices such as personal computers (e.g., laptops, tablet computers, cellular telephones, etc.). In some embodiments, such as if the remote resources 102 are personal computers or smartphones, the processing described herein may be shared by a remote resource 102 and the touchscreen electronic device 104. The remote resources 102 may also include game consoles, network management devices, field programmable gate arrays, etc. In addition, multiple remote resources 102 and/or touchscreen electronic devices 104 may be concurrently operating within a single system 100.

The network 106 may be any type of known network including, but not limited to, a wide area network (WAN), a local area network (LAN), a global network (e.g. Internet), a virtual private network (VPN), a cloud network, and an intranet. The network 106 may be implemented using a wireless network or any kind of physical network implementation known in the art. A remote resource 102 may be coupled to the touchscreen electronic device 104 through multiple networks 106 (e.g., cellular and Internet) so that not all remote resources 102 are coupled to the touchscreen electronic device 104 through the same network 106. One or more of the remote resources 102 and the touchscreen electronic device 104 may be connected to the network 106 in a wireless fashion. In one non-limiting embodiment, the network is the Internet and one or more remote resources 102 and/or the touchscreen electronic device 104 execute a user interface application (e.g. a web browser or app) to communicate to each other through the network 106.

In another non-limiting example embodiment, the remote resource 102 may be connected directly (i.e., not through the network 106) to the touchscreen electronic device 104. That is, as shown, a direct or dedicated communication link 108 may be formed between the touchscreen electronic device 104 and the remote resource 102 (e.g., a smartphone). Such connection may be made by Bluetooth® connection or other near-field communication protocol.

In some embodiments, the touchscreen electronic device 104 may be configured to access one or more programs, applications, and/or software that are accessible in the cloud, e.g., stored on one or more Internet based servers. As such, a storage device or remote server may be implemented as one of the remote resources 102 using a variety of devices for storing electronic information. In an example embodiment, data stored in the storage device or remote server may include, but is not limited to, one or more user applications and/or data, including but not limited to, a user's scheduling information, weather information, transportation information, etc., and other data utilized by embodiments described herein. It is understood that the remote server or storage device may be implemented using memory contained on a remote resource 102 or that it may be a separate physical device, e.g., an internet server with cloud storage. The storage device remote resource 102 may be logically addressable as a consolidated data source across a distributed environment that includes the network 106. Information stored in the storage device may be retrieved and manipulated via the touchscreen electronic device 104 and/or via another remote resource 102, e.g. a laptop or smartphone.

The touchscreen electronic device 104 may be based on a modular concept designed to include a motherboard or base card of minimum card size that may be configured for enabling various functions. For example, the base card of the touchscreen electronic device may be implemented in a basic shell providing desktop-like functionality via a touchscreen display, a communications interface (e.g., GPS and cellular communications capability), etc. may be provided within the base card. The touchscreen electronic device 104 may be provided with a processor or controller, memory, and various other electronic components configured to enable a user interface on the touchscreen electronic device 104 to enable a user to interact with programs and applications stored on the touchscreen electronic device 104 and/or to communicate and interact with one or more programs and applications stored on the one or more remote resources 102.

The touchscreen electronic device 104, in some embodiments, may execute one or more computer programs, e.g., a scheduling application, to provide aspects of embodiments as described herein. Processing may be shared by the touchscreen electronic device 104 and one or more of the remote resources 102. Alternatively, the touchscreen electronic device 104 can include stand-alone software application(s) for performing a portion or all of the processing described herein. As previously described, it is understood that separate servers may be utilized to implement network server functions and application server functions. Alternatively, a network server, a firewall, and an application server may be implemented by a single server executing computer programs to perform the requisite functions.

In accordance with embodiments described herein, a user may use a touchscreen electronic device 104 to view and/or access time-sensitive information from one or more remote resources 102.

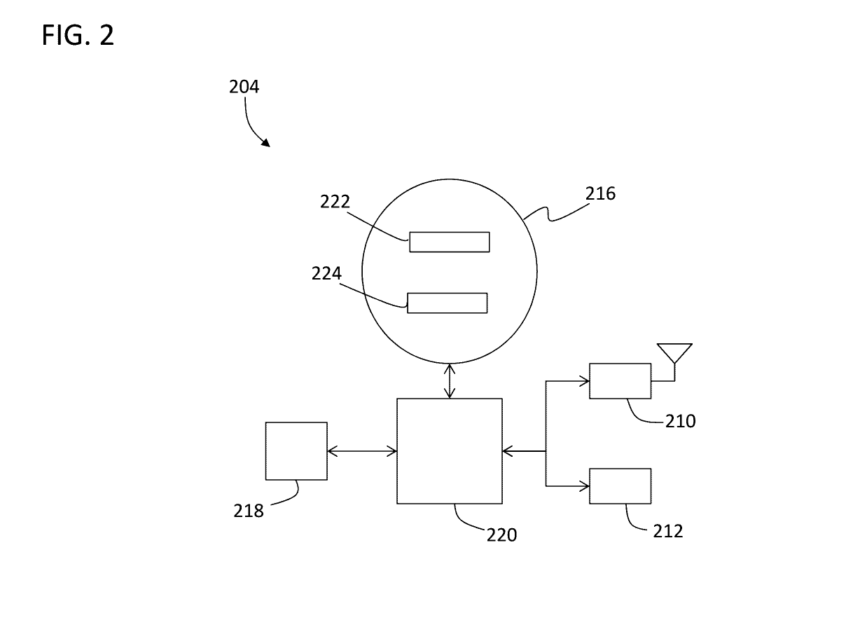

Turning now to FIG. 2, a schematic block diagram illustration of a touchscreen electronic device 204 that may provide functionality as described herein is shown. Again, as shown, the touchscreen electronic device 204 is depicted as a smartwatch, although those of skill in the art will appreciate that any type of electronic devices having a touchscreen may employ embodiments described herein. Referring to FIG. 2, the touchscreen electronic device 204 may include a wireless communication unit 210, an interface unit 212, a touchscreen 216, a storage unit 218, and a controller 220 which may be a processor or other processing device. The touchscreen 216 may include a display unit 222 and a touch detector 224.

The wireless communication unit 210 may form wireless communication channels with other devices located within a communicable range, e.g., remote resources 102 shown in FIG. 1. The wireless communication unit 210 according to an embodiment of the present disclosure may form a wireless communication channel with a remote or external remote resource or user device to send requests and receive time-sensitive information for a user-defined time from the remote resource through the wireless communication channel. The wireless communication unit 210 may use a wireless communication technology such as Bluetooth®, infrared communication, Wi-Fi, P2P, cellular data, Wi-Fi Direct, home RF, DLNA, ZigBee, or the like.

The interface unit 212, which may be optionally implemented in embodiments, may include a wired cable for a wired connection with the remote resource (rather than wirelessly) and may send requests and receive time-sensitive information data for a user-defined time through the wired cable. Accordingly, the interface unit 212 may be formed by a USB, a micro/mini USB, an HDMI, a 20-pole connector, or the like. In some embodiments, the interface unit 212 may be omitted.

The touchscreen 216 may perform an input function and an output function. For these functions, the touchscreen 216 may include the display unit 222 for performing the output function and the touch detector 224 for performing the input function. The display unit 222 may be configured to display information of an application executed on the touchscreen electronic device 204, information input by a user, and/or information to be provided to the user. For example, the display unit 222 may provide work areas for various applications such as a schedule management application, a note application, a picture viewer, and a game according to the use of the touchscreen electronic device 204. The display unit 222 may also be configured to display a time or other time related information on the touchscreen 216, as known in the art.

The touch detector 224 may generate an input event according to a contact or a detection of a user's finger or a stylus and transmit the generated input event to the controller 220. The touch detector 224 may recognize a change in a physical quantity (for example, capacitance, resistance, pressure, or the like) according to a physical contact or approach of the finger or the stylus, and transmit the input event including a type of the input and information on a position where the input is detected to the controller 220, e.g., where a user touches a face of the touchscreen electronic device 204.

The storage unit 218 may store a program code required for operations according to an embodiment of the present disclosure, user data, applications, programs, other information, or the like. For example, the storage unit 218 may store a program that controls general operations of the touchscreen electronic device 204, applications required for an Operating System (OS) booting the touchscreen electronic device 204, and additional functions of the touchscreen electronic device 204, such as a camera function, a sound play function, an image editing function, an image display function, a video play function, a wireless communication function, or the like. In some embodiments, the storage unit 218 may store time-sensitive information, such as schedule data including one or more schedule items input by the user under a control of the controller 220 and provide the schedule data for display when there is a request of the controller 220 through the touch detector 224. The storage unit 218 may store user interface (“UI”) composition information indicating time-sensitive information that is arranged in a form suitable for screen information of the touchscreen electronic device 204 (e.g., a physical shape such as a rectangle, a circle, an oval, a polygon, etc., a resolution, and/or a size) under a control of the controller 220 and provide the UI composition information to the controller 220 when there is a request of the controller 220 to display information on the touchscreen 216.

The controller 220 may control general operations of the touchscreen electronic device 204 and a flow of information and/or signals between components within the touchscreen electronic device 204. For example, when there is a request by a user for displaying time-sensitive information detected by the touch detector 224, the controller 220 may generate and transmit a request to a remote resource through a schedule management application, using the communication unit 210. The controller 220 may then receive information, through the communication unit 210, to then be displayed on the touchscreen 216 using the display unit 222.

In an embodiment, the controller 220 may reconfigure the time-sensitive information received from a remote resource into a form suitable for being displayed on the touchscreen 216 of the touchscreen electronic device 204 according to display screen information of the touchscreen electronic device 204. For example, the controller 220 may reconfigured the time-sensitive information to fit a display shape, a size, and a resolution of the touchscreen 216. The controller 220 may transmit UI composition information indicating reconfigured time-sensitive information to the display unit 222 for display on the touchscreen 216.

Although not illustrated in FIG. 2, the touchscreen electronic device 204 may further include optional components for providing additional functions and/or features, such as a camera module for photographing an image or a video, a broadcasting reception module for receiving broadcasts, a digital music play module such as MPEG audio layer-3 (MP3), a proximity sensor module for proximity sensing, a microphone for receiving audio inputs, and/or other components as known in the art. As will be appreciated by those of skill in the art, the touchscreen electronic device 204 and touchscreen electronic devices as described herein may include various other components not explicitly shown or described.

In accordance with embodiments described herein, the touchscreen 216 may be configured such that the touch detector 224 can detect touching at different portions of a face of the touchscreen 216 to present different functions. For example, even though the touchscreen electronic device 204 may not display a traditional clock face (e.g., the display of time is digital numbers rather than an analog clock face), the touch detector 224, in connection with a face of the touchscreen 216, may detect specific time or time duration based on where on the touchscreen 216 a user touches, i.e., a user-defined time.

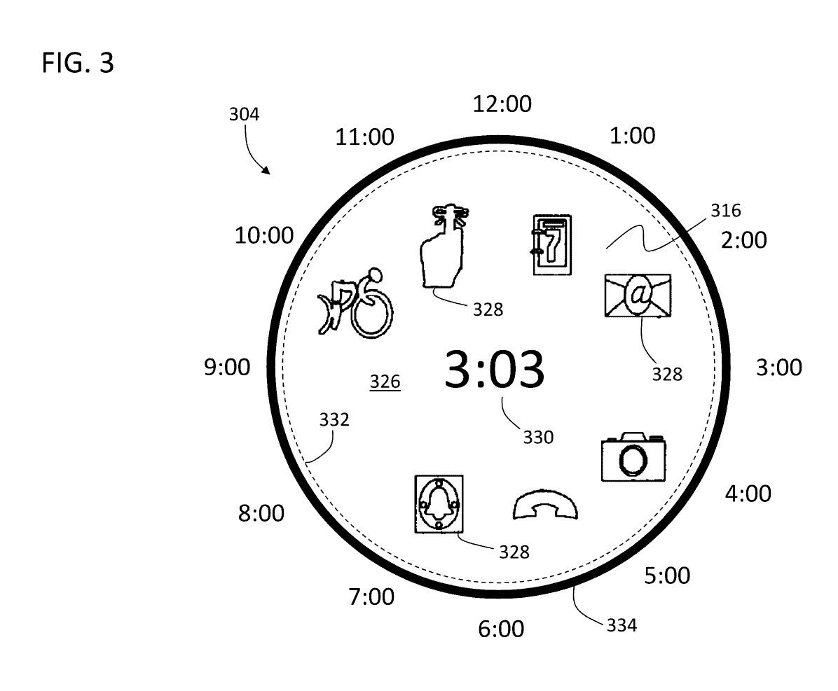

Turning now to FIG. 3, an example face of a touchscreen electronic device 304 having a touchscreen 316 is shown. The touchscreen electronic device 304 may be used to display information on a face 326 to a user related to scheduling or other time-sensitive information. For example, various applications stored on the touchscreen electronic device or on one or more remote resources may be time-based and specific time-sensitive information obtained from or related to the time-based applications may be desired to be displayed on the face 326 of the touchscreen electronic device 304. Applications that are time-based may include, but are not limited to, calendar applications (e.g., calendar information including meetings, appointments, etc.), a movie time application, TV network application, or concert information application (e.g., entertainment information including movie or show times), a weather application (e.g., weather information including hour-by-hour weather), a train or airline application (e.g., transportation information including schedules, departures, arrivals), etc. Hereinafter, applications as described above will be referred to as time-based applications and the information associated therewith or obtained therefrom is time-sensitive information.

As provided herein, an overlay of a traditional analog clock face is provided on an edge 334 of the face 326 of the touchscreen 316 to enable touch-point functionality to the touchscreen electronic device 304. Embodiments disclosed herein may enable a user to initiate a time-sensitive information search request via the touchscreen electronic device 304 by touch of the face 326 of the touchscreen electronic device 304. Further, embodiments provided herein may allow specific time slot information from time-based applications to be channeled and displayed on the face 326 of the touchscreen electronic device 304. Further, the touchscreen electronic device 304 may be paired with multiple remote resources to allow search results from multiple remote resources to be displayed on the face 326 of the touchscreen electronic device 304.

As shown in FIG. 3, rather than display a traditional analog clock face, the face 326 of the touchscreen 316 may provide icons 328 for various applications that may be stored and run on the touchscreen electronic device 304 and/or may be stored on a remote resource (not shown) and accessible from the touchscreen electronic device 304. Further, a digital time 330 may be displayed on the face 326 of the touchscreen 316. As shown, a traditional clock face is not displayed on the face 326, in part due to the amount of space available on the face 326 while accommodating the icons 328. That is, because of the functionality of the touchscreen electronic device 304, a traditional analog clock face for indicating time is not used to enable display of icons 328 and/or a digital time 330.

However, the touchscreen electronic device 304 may include traditional analog clock face functionality when a traditional analog clock face is not shown. That is, a time-based touch region 332 may be positioned at a periphery, perimeter, or edge 334 on the face 326 of the touchscreen 316. The time-based touch region 332 may be a touch-region that is a continuous touch sensitive region or surface of the touchscreen 316 that is programmed to have each portion (or point) along the circumference of the edge 334 correspond to a time on a traditional clock face (e.g., as shown labeled about the edge 334 of the touchscreen 316). That is, the time-based touch region 332 may be a region about the edge 334 of the face 326 that is touch- and time-mapped to a traditional analog clock face configuration, wherein each point along the time-based touch region 332 is mapped to and corresponds with a time on a traditional analog clock face, even though the traditional analog clock face is not displayed on the face 326.

As provided herein, when using the time-based touch region 332 functionality of the touchscreen electronic device 304, touching the edge 334 of the face 326 for a specific time (e.g., single tap for AM, double tap for PM) may enable a user to access time-sensitive information related to the user-defined time. Further, a tap and drag along the edge 334 of the touchscreen 316, about the time-based touch region 332, can indicate a time window or range of time. When such a touch is made by a user, the touchscreen electronic device 304 may be configured to send a request to a connected remote resource to obtain time-sensitive information related to the user-defined time. The response to the request may then be received by the touchscreen electronic device 304 and displayed on the face 326 of the touchscreen 316. As will be appreciated by those of skill in the art, the time-based touch region 332 does not correspond to the icons 328 displayed on the face 326 of the touchscreen 316, but rather to points associated with a traditional analog clock face.

The time-based touch region 332 may enabled obtaining time-sensitive information from one or more various time-based applications. When a user touches the time-based touch region 332, a controller of the touchscreen electronic device 304 may transmit a query to one or more remote resources (e.g., a connected user device, the internet, etc.) to obtain information from one or more time-based applications associated with a user-defined time. That is, a user may touch a portion of the time-based touch region 332 on the touchscreen electronic device 304 and have time-sensitive information related to scheduling and/or time be displayed on the face 326 of the touchscreen 316.

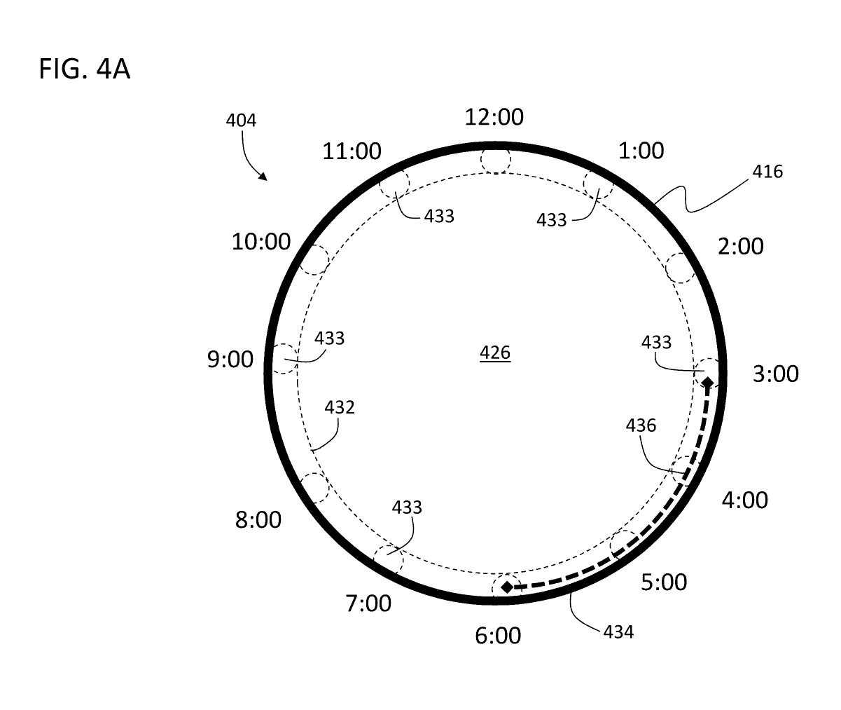

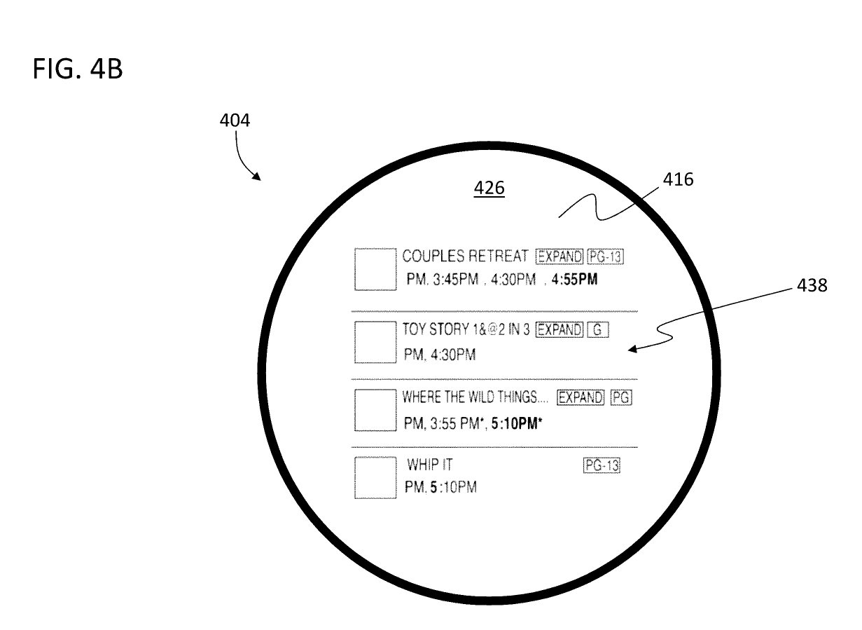

Turning now to FIGS. 4A and 4B, an example of a touchscreen electronic device in accordance with a non-limiting embodiment of the present disclosure is shown. In FIGS. 4A and 4B, a touchscreen electronic device 404 may be connected to or paired with one or more remote resources (e.g., the touchscreen electronic device 404 may have an internet connection or may be paired with a user device with an internet connection or the like). The touchscreen electronic device 404 may be configured as described above, and thus may include a time-based touch region 432 configured about an edge 434 on a face 426 of a touchscreen 416.

As shown, the time-based touch region 432 configured about the edge 434 of the touchscreen 416 may be configured with a plurality of positions 433. The positions 433 may be positioned or mapped at points on the edge 434 of the face 426 such that each region corresponds to a time on a traditional analog clock face. For example, one position 433 may correspond with the time 12:00 (12 o'clock) on an analog clock face and another position 433 may correspond with the time 1:00 (1 o'clock) on an analog clock face. Further, as shown, the time-based touch region 432 may be continuous, with portions of the time-based touch region 432 extending about the entire circumference of the face 426.

The touchscreen electronic device 404 may be configured such that when the time-based touch region 432 is touched by a user, the touchscreen electronic device 404 may make an inquiry to one or more remote resources that has time-sensitive information. That is, when a user touches the time-based touch region 432 on the touchscreen electronic device 404, the touchscreen electronic device 404 may be configured to retrieve and display time-sensitive information related to the indicated time, i.e., a user-defined time. For example, as shown in FIG. 4A, a user may touch a user-defined time 436 of the time-based touch region 432, by touching a first position 433 and sliding their finger along the edge 434 to a second position 433. In this example, the user-defined time 436 corresponds to a time period extending from 3:00 to 6:00. Those of skill in the art will appreciate that the user-defined time may be any time duration or may be a single point, such as just 3:00 or 3 o'clock, i.e., pressing or touching at a single position 433 along the time-based touch region 432.

With the user-defined time 436 touched or activated, as shown in FIG. 4A, the touchscreen electronic device 404 may register the time period 3:00 to 6:00 and send a request or query to one or more remote resources to obtain time-sensitive information for the period of 3:00 to 6:00. The touchscreen electronic device 404 will then receive the requested time-sensitive information and process the time-sensitive information to be displayed on the face 426 of the touchscreen 416.

For example, as shown in FIG. 4B, the face 426 of the touchscreen 416 may display time-sensitive information 438. In the example of FIG. 4B, the time-sensitive information 438 is related to movie times. That is, a user of the touchscreen electronic device 404 may view movie times that are available between the times of 3:00 and 6:00 by generating a user-defined time 436 by touching one or more regions 433 along the edge 434 of the face 426 that are part of the time-based touch region 432.

Because a traditional clock face is configured in a 12-hour period, in some embodiments, the touchscreen of the touchscreen electronic devices provided herein may be configured to receive an input that indicates A.M. or P.M. For example, a single tap of the edge of the face of the touchscreen electronic device, prior to indicating a user-defined time, may indicate A.M., and a double tap of the edge of the face of the touchscreen electronic device, prior to indicating a user-defined time, may indicate P.M. As such, a user's desired time period may be indicated and appropriate results may be displayed to the user.

In other embodiments, rather than a time period or time range, a user touching the edge may indicate a specific time. For example, when a user touches a position along the edge of the face of the touchscreen electronic device, time-sensitive information related to that time may be displayed.

Further, as noted above, various types of time-based applications may be used with a touchscreen electronic device as described herein. For example, a user may touch a point on the edge of the face of the touchscreen electronic device, and rather than movie times, the time-sensitive information may include any scheduled appointments or meetings that are saved in a calendar application may be displayed to the user (calendar information). In other embodiments, the time-sensitive information may be entertainment information, transportation information, weather information, or other information that may be time-dependent.

In accordance with some embodiments, the user may define the time-based applications that may be queried when the time-based touch region of the touchscreen electronic device is touched. That is, the user may define the particular type of time-sensitive information or time-based applications that will be queried and/or displayed in a request made using a time-based touch region on a touchscreen electronic device.

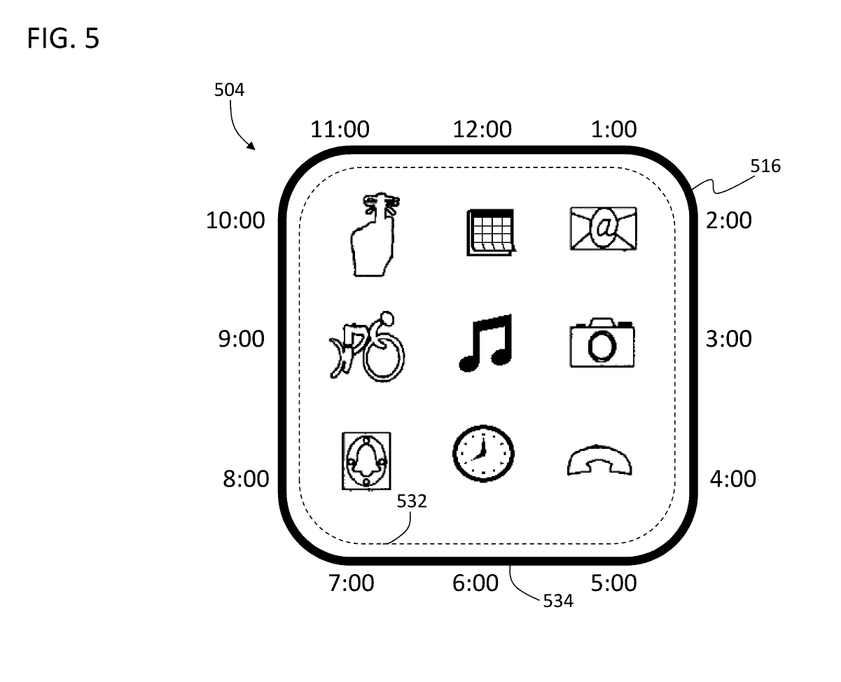

FIG. 5 shows an example of another configuration of a touchscreen electronic device in accordance with an embodiment of the present disclosure. As shown and described above, the touchscreen electronic device of FIGS. 3 and 4A-4B is circular. However, the present functionality is not limited to a circular face. That is, although a traditional analog clock face geometry is circular, a time-based touch region 532 may be configured about an edge 534 of a touchscreen 516 on a non-circular shaped touchscreen electronic device 504, e.g., for a smartphone, tablet, etc. In such an embodiment, the times of a traditional clock face may be mapped to appropriate positions about the edge 534.

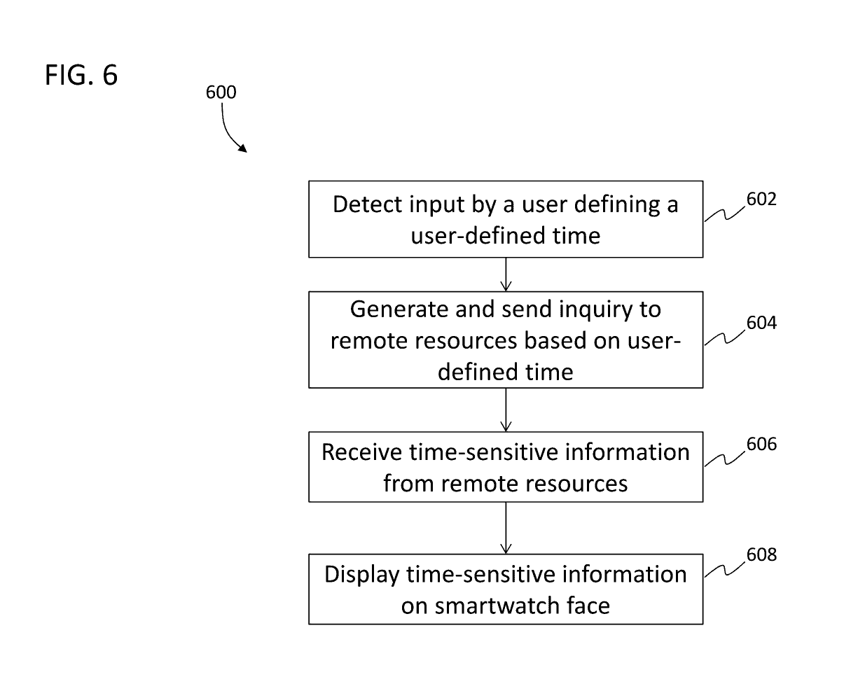

Turning now to FIG. 6, a flow process in accordance with a non-limiting embodiment of the present disclosure is shown. Flow process 600 may be performed by a touchscreen electronic device as shown and described above or by similar devices, including but not limited to smartwatches, smartphones, tablets, etc. As such, a touchscreen electronic device may include a touchscreen with a time-based touch region configured about an edge of the face of the touchscreen electronic device. Further, the time-based touch region may be part of an application or software stored on a memory device of the touchscreen electronic device, and a controller or other processor can, based on the application or software, map points on the edge of the face of the touchscreen electronic device to correspond to a traditional or analog clock face.

Further, the touchscreen electronic device may be configured to communicate with one or more remote resources to obtain time-sensitive information from the one or more remote resources. In some embodiments, the remote resource may be a wirelessly paired user device such as a smartphone or tablet. In other embodiments, the remote resource may be a server or other cloud-based computing device and the touchscreen electronic device may have internet access capabilities to communicate with the server or other cloud-based computing device. In some embodiments, the internet connection of the touchscreen electronic device may be provided through a paired remote resource, such as a paired smartphone. In some embodiments, the touchscreen electronic device may be configured to communicate with multiple remote resources.

The touchscreen electronic device may be configured such that the time-based touch region application or software may receive user input regarding remote resources and/or time-sensitive information on the remote resources that should be obtained and displayed when the time-based touch region is used. For example, a time-based touch region application on a touchscreen electronic device may have settings such that a user may input desired queries to be made to one or more remote resources when the time-based touch region of the touchscreen electronic device is used. Thus one or more time-based applications on one or more remote resources may be user defined and/or pre-defined or preset by a user.

Once the touchscreen electronic device is setup and configured with the one or more remote resources, the touchscreen electronic device may detect an input by the user, as shown at block 602. The detection may be a touch or multiple touches made at an edge of the touchscreen electronic device that is a time-based touch region. The touch or touches may be used to define a user-defined time that forms the basis of a request for time-sensitive information to be displayed on the touchscreen electronic device.

Based on the touch, a controller or processor of the touchscreen electronic device may generate an inquiry to be sent to the one or more remote resources, as shown at block 604. The inquiry may be a request for time-sensitive information that is stored on or obtainable through or from the one or more remote resources. That is, the inquiry may be a data packet that includes a request for time-sensitive information, wherein the request includes the user-defined time indicated by the user input detected by the touchscreen electronic device. The touchscreen electronic device may then use the connection or communication link between the touchscreen electronic device and the one or more remote resources to send the inquiry to the one or more resources.

The one or more remote resources may transmit time-sensitive information in response to the inquiry from the touchscreen electronic device, and the touchscreen electronic device may receive such transmitted time-sensitive information at block 606. The time-sensitive information may be any time-sensitive information based on the inquiry, and thus may include time-sensitive information obtained from one or more applications or sources from the one or more remote resources.

The touchscreen electronic device may then process and/or configure the time-sensitive information received to be displayed on a face of the touchscreen electronic device, as shown at block 608. For example, the touchscreen electronic device may process the time-sensitive information into a display configuration that fits the size, shape, and pixel requirements of the face of the touchscreen electronic device, and then display such modified information on the screen of the touchscreen electronic device.

As such, in accordance with embodiments described herein, a user may enter a specific time slot by touching a specific area on a touchscreen electronic device face as shown and described above, that is, the user may generate a user-defined time. The touch of the touchscreen electronic device face will be translated as a specific time, e.g., 6 pm, or duration, e.g., 6 pm-9 pm. In some embodiments, a specific time may be based on a single touch (or multiple touches) at a specific location on an edge of the touchscreen electronic device and a duration or range of time may be based on a dragging motion (or multiple motions) along the edge of the face of the touchscreen electronic device. The specified time or time slot, i.e., the user-defined time, may be sent to one or more remote resources via a communication protocol and link used by the touchscreen electronic device.

Upon receiving an inquiry from a touchscreen electronic device, in accordance with the present disclosure, a paired user device(s) (or other remote resource) may use the user-defined time as input for searching and obtaining responsive time-sensitive information. In accordance with one or more embodiments, if a specific search is not pre-defined in the request sent by the touchscreen electronic device, the receiving remote resources may search all time-based applications stored thereon (or time-sensitive information). Results that are obtained from the time-based applications will be sent back from the remote resources to the requesting touchscreen electronic device. The time-sensitive information may then be processed and displayed on the face of the touchscreen electronic device for a user to view.

In some embodiments, as mentioned above, one or more remote resources and/or one or more time-based applications may be queried by a request from the touchscreen electronic device. Thus, multiple results may be received by the touchscreen electronic device for display to the user, and in some embodiments, the results may not be directly related. For example, the results may include weather information for the indicated time period, a doctor appointment within the time period, and movie information within the time period. As such, it may not be appropriate or possible for the touchscreen electronic device to display all of the time-sensitive information on a single view/screen of the touchscreen electronic device. Thus, in accordance with some embodiments, a touchscreen electronic device may include a toggling capability to switch between and/or have a user select and view specific time-sensitive information received from a request. In one non-limiting embodiment, in order for the user to toggle between various time-sensitive information received from different applications or sources the user can touch the middle portion of the touchscreen electronic device face or use any buttons available on the touchscreen electronic device to navigate between the results. For example, to switch from one set of time-sensitive information to another (e.g., switching between information from two different sources), the touchscreen of the touchscreen electronic device may be used to swipe or move between different information. In other embodiments, a knob or other physical or analog mechanism can be used for switching between various time-sensitive information. In other embodiments a combination of touchscreen and analog mechanisms may be used for navigating between various time-sensitive information.

In another embodiment, a user may pre-select a specific set of time-sensitive information that the user wishes to view. For example, a user may identify on the touchscreen electronic device that they want to view movie times. In such a configuration, the user may touch the edge of the touchscreen electronic device along the time-based touch region and an inquiry will be sent for just movie times within or associated with a user-defined time. The touchscreen electronic device may then generate a request based on this information and send it to one or more remote resources and the one or more remote resources may reply with the appropriate time-sensitive information. Thus, in accordance with some embodiments, a user may select one or more sets of time-sensitive information (e.g., a specific application to be queried that is located on a connected remote resource). As such, in some embodiments the selection and inquiry can be sent to a specific connected remote resource to launch a request with the specific time or time window. Further, in some embodiments, if the touchscreen electronic device has a direct internet connection (e.g., cellular or Wi-Fi connection), the request (including, e.g., a specific application and the selected time or time window) may be sent directly over the internet to launch the application on behalf of the user and obtain the time-sensitive information directly over the internet connection.

In an alternative embodiment, which may be configured in combination with the above described embodiments and features, a user may use the time-based touch region to set up a reminder, scheduled event, or similar item that is sent to a connected remote resource for processing. For example, a user could hold down on a position on the time-based touch region of the touchscreen electronic device to set up a calendar entry, to-do, reminder, etc. on a connected remote resource (such as a connected smartphone). In one non-limiting example, a user may press or touch a position on the time-based touch region corresponding with 6:00 P.M. (e.g., the bottom of the touchscreen electronic device face) and then speak an instruction, e.g., “pick up Jon from school.” Then, rather than sending an inquiry to the connected remote resource to obtain time-sensitive information, a data point and associated information may be sent to the remote resource. For example, the touchscreen electronic device may generate a calendar reminder and send the information to a connected smartphone to enter the information into a calendar application on the smartphone. Thus, the smartphone may receive the information and create a reminder or other scheduled event (6:00 P.M. to pick up Jon) on the smartphone based on input at the touchscreen electronic device.

Technical effects and benefits include overlaying or mapping a traditional or analog clock face to a time-based touch region on a touchscreen of a touchscreen electronic device. Further technical effects include enabling a user to initiate a time-based application search request via paired a touchscreen electronic device by touch of a face of the touchscreen electronic device. Further technical effects include enabling specific time slot information from time-based applications to be channeled and displayed on a paired touchscreen electronic device with the information obtained from a paired smartphone or other user device or remote resource. Further technical effects enable one touchscreen electronic device to be paired with multiple user devices and/or remote resources to enable multi-device searching and information gathering. Thus, embodiments described herein may enable search result from multiple user devices and/or remote resources to be displayed in a single touchscreen electronic device display interface. Further technical effects include generating a scheduling item based on touching a time-based touch region of a touchscreen electronic device and sending a request to a paired user device, and the scheduling item may then be entered into a calendar or other application.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the invention for various embodiments with various modifications as are suited to the particular use contemplated.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed:

1. A touchscreen electronic device comprising:
a touchscreen having a face defining an edge;
a processor configured to control the touchscreen electronic device, wherein the processor is configured to control images displayed on the face and detect user input through the touchscreen; and
a time-based touch region defined at the edge of the face, the time-based touch region having a plurality of positions mapped to points around the edge, wherein each position of the plurality of positions corresponds to a time on a traditional analog clock face.

2. The touchscreen electronic device of claim 1, wherein the processor is configured detect a user input at one or more of the positions on the time-based touch region and generate an inquiry based on the user input.

3. The touchscreen electronic device of claim 2, wherein the touchscreen electronic device is configured to transmit the inquiry to a remote resource.

4. The touchscreen electronic device of claim 3, wherein the touchscreen electronic device is configured to receive time-sensitive information related to the inquiry from the remote resource and display the time-sensitive information on the face of the touchscreen electronic device.

5. The touchscreen electronic device of claim 1, wherein the touchscreen electronic device is one of a smartwatch, a smartphone, or a tablet.

6. The touchscreen electronic device of claim 1, wherein the touchscreen electronic device is configured to receive audio input from a user, wherein the processor is configured to receive as input a user input on the time-based touch region and the audio input to generate a scheduled event.

7.-13. (canceled)

14. A system to display time-sensitive information on a touchscreen electronic device comprising:
a memory having computer readable instructions; and
a processor configured to execute the computer readable instructions, the computer readable instructions comprising:
detecting, by the processor in the touchscreen electronic device, a user-defined time detected along a time-based touch region located at an edge of a face of the touchscreen electronic device;
generating an inquiry based on the detected user-defined time;
transmitting the inquiry to at least one remote resource;
receiving at the touchscreen electronic device time-sensitive information from the at least one remote resource; and
displaying the time-sensitive information on the face of the touchscreen electronic device.

15. The system of claim 14, wherein the time-based touch region includes a plurality of positions mapped to points around the edge, wherein each position of the plurality of positions corresponds to a time on a traditional analog clock face.

16. The system of claim 14, wherein the user-defined time is one of a specific time and a range of time.

17. The system of claim 14, wherein the touchscreen electronic device is one of a smartwatch, a smartphone, or a tablet.

18. The system of claim 14, wherein the transmitting and receiving are performed over a dedicated communication link between the touchscreen electronic device and the at least one resource.

19. The system of claim 14, wherein the time-sensitive information comprises weather information, entertainment information, transportation information, or calendar information.

20. The system of claim 14, the computer readable instructions further comprising:
receiving audio input from a user; and
generating a scheduled event based on the audio input and the user-defined time.
